(19) United States
(12) Patent Application Publication
(10) Pub. No.: US 2014/0101952 A1
(43) Pub. Date: Apr. 17, 2014

(54) Multi-Axis Educational Graphing Ruler

(71) Applicant: Margaret Schmitten, Santee, CA (US)

(72) Inventor: Margaret Schmitten, Santee, CA (US)

(21) Appl. No.: 14/056,754

(22) Filed: Oct. 17, 2013

Related U.S. Application Data
(60) Provisional application No. 61/715,265, filed on Oct. 17, 2012.

(51) Int. Cl. B43L 13/00; G01B 3/04

(52) U.S. Cl. CPC B43L 13/001; G01B 3/04
USPC 33/493; 33/494

(57) ABSTRACT

A multi-axis educational graphing ruler is described. The ruler includes: a first set of markings placed such that the markings extend vertically if the ruler is placed in a first orientation; and a second set of markings oriented such that the markings extend horizontally if the ruler is placed in a second orientation that is perpendicular to the first orientation. A ruler includes: a first set of markings and labels associated with a first axis; and a second set of markings and labels associated with a second axis that is perpendicular to the first axis. A plotting tool includes: a first set of markings and labels along a first surface of the tool; and a second set of markings and labels along a second surface of the tool, wherein the second surface is perpendicular to the first surface.

### CROSS-REFERENCE TO RELATED APPLICATIONS

This application claims priority to U.S. Provisional Patent Application Ser. No. 61/715,265, filed on Oct. 17, 2012.

### BACKGROUND OF THE INVENTION

Many people, such as students, may be asked to plot various points, functions, etc. Many such people may have difficulty using a typical single-axis ruler. For instance, some people may not be able to easily orient the ruler and determine a relative location along the ruler when attempting to plot a point with multiple coordinates. As another example, some people may have difficulty in determining a location associated with a negative value when using a ruler that has only positive labels.

Thus there exists a need for a ruler that is able to be easily oriented relative to multiple axes and that includes positive and negative markings

### BRIEF SUMMARY OF THE INVENTION

Some embodiments of the invention provide a multi-axis educational graphing ruler. Such a ruler may include multiple sets of markings such that the ruler may be oriented in different ways to allow use of the markings. A first set of markings may correspond to a first axis (e.g., an “X” axis) or number line. A second set of markings may correspond to a second axis (e.g., a “Y” axis). The markings may correspond to various measurement indicators on the ruler. The markings may include indications corresponding to negative values along one or more axes of the ruler. The measurement indicators may be spaced at various appropriate distances along an edge of the ruler.

Each set of markings may correspond to a particular orientation of the graphing ruler. For instance, a first orientation may position the ruler in a horizontal direction along a graphing medium (e.g., graph paper). The first orientation may place a first edge of the ruler in a horizontal direction that is parallel to the x-axis of the graph being generated. The second orientation may place a second edge of the ruler in a vertical direction that is parallel to the y-axis of the graph being generated. Each set of markings may include a zero value that may be aligned with the alternate axis when generating a graph (e.g., the x-axis zero value may be aligned with the y-axis in the first orientation, while the y-axis zero value may be aligned with the x-axis in the second orientation).

Such rulers may quickly and easily allow students to plot points when graphing mathematical formulae, functions, sets of values, and/or other types of graphing endeavors. Each student may be able to place the ruler in the first orientation, align the y-axis marker (i.e., the zero value marking along the x-axis) and determine the position of an x value to be plotted. The student may then rotate the ruler (e.g., ninety degrees counterclockwise) to place the ruler in the second orientation, align the x-axis marker (i.e., the zero value marking along the y-axis) and determine the position of a y value to be plotted.

A first exemplary embodiments provides a multi-axis educational graphing ruler including: a first set of markings placed such that the markings extend vertically if the ruler is placed in a first orientation; and a second set of markings oriented such that the markings extend horizontally if the ruler is placed in a second orientation that is perpendicular to the first orientation.

A second exemplary embodiment provides a ruler including: a first set of markings and labels associated with a first axis; and a second set of markings and labels associated with a second axis that is perpendicular to the first axis.

A third exemplary embodiment provides a plotting tool including: a first set of markings and labels along a first surface of the tool; and a second set of markings and labels along a second surface of the tool, wherein the second surface is perpendicular to the first surface.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIG. 1 illustrates front views of a graphing ruler according to an exemplary embodiment the invention; and

FIG. 2 illustrates front, side, and top views of an alternative graphing ruler according to an exemplary embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features. Broadly, some embodiments of the present invention generally provide a multi-axis educational graphing ruler.

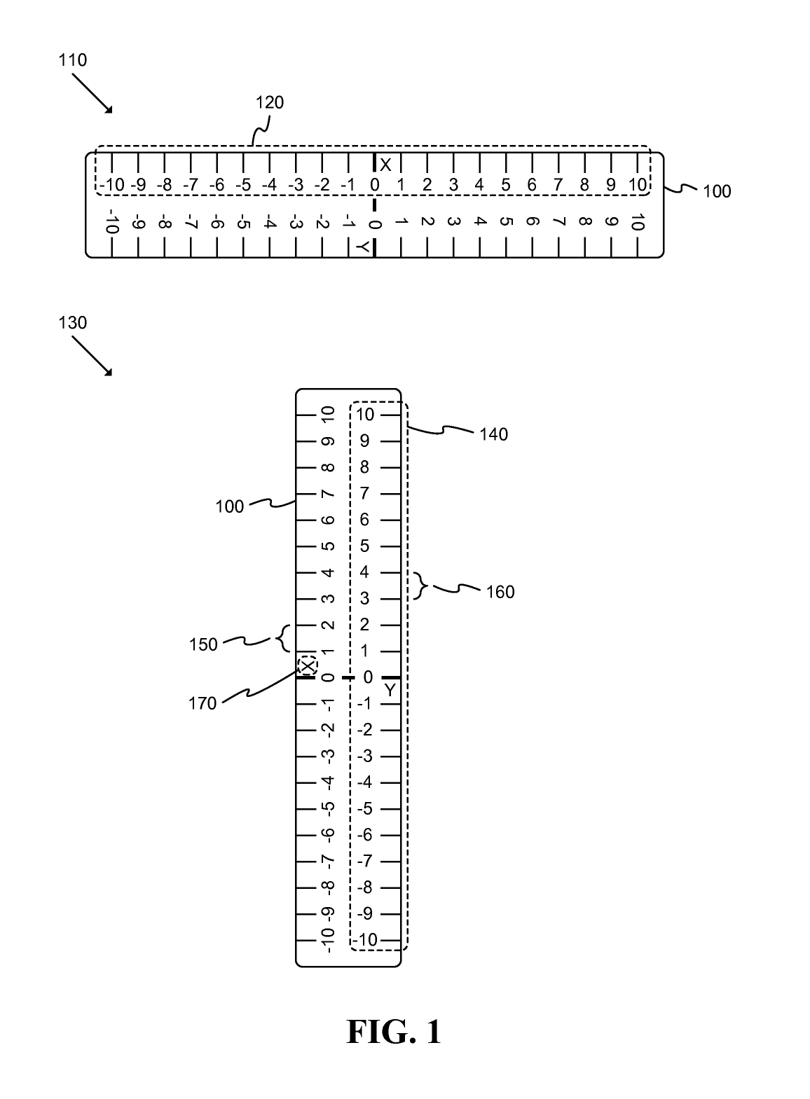

FIG. 1 illustrates front views of a graphing ruler 100 according to an exemplary embodiment the invention. Such rulers may have varying lengths, widths, and/or thicknesses, as appropriate. The ruler may be made of various appropriate materials (e.g., plastic, metal, wood, etc.). In some embodiments, the ruler may be at least partially transparent such that elements associated with a graphing medium (e.g., gridlines, previously plotted points, etc.) may be visible while the ruler is being used.

The size, shape, and/or other attributes of the ruler may be based at least partly on various attributes of the user and/or other appropriate factors (e.g., materials used, size of graphical elements, desired grid spacing, etc.). For instance, the rulers may have varying attributes based on intended age, education level, mathematic aptitude, etc. of the user or users. In one example embodiment, the rule may be approximately seven inches long, approximately one-and-a-half inches wide, and approximately one thirty-second of an inch thick.

As shown, in a first orientation 110, the ruler 100 may be aligned such that a first set of markings 120 (and associated labels), corresponding to points along an “X” axis, is placed in an upright position. Likewise, in a second orientation 130, the ruler may be aligned such that a second set of markings 140 (and associated labels), corresponding to points along a “Y” axis, is placed in an upright position. As shown, in some embodiments each set of markings may be centered on a value of zero and extend in positive and negative directions (with associated positive and negative labels). Each marking may be associated with a particular label.

The first set of markings may have a first spacing 150 and the second set of markings may have a second spacing 160. In the example of FIG. 1, the markings 120 and 140 are evenly spaced and uniform across the two axes. The spacing between the markings along each axis may correspond to grid spacing provided by various types of graph paper and/or other mediums (e.g., one-quarter inch spacing between markings for use with standard graph paper). One of ordinary skill in the art will recognize that the markings may be spaced at uneven intervals and may be non-uniform across the axes. The markings may correspond to various appropriate coordinate systems (e.g., Cartesian coordinate system, polar coordinate system, cylindrical and spherical coordinate systems, etc.).

For instance, some embodiments may utilize spacings associated with a trigonometric scale that is based on various values along a unit circle. Such scales may be used to plot functions such as sin functions, cosine functions, and/or other trigonometric functions, as appropriate. As another example, some scales may be adapted to be used to plot logarithmic functions. As yet another example, some scales may be used to plot calculus functions. Various other scales may be associated with various other functions (e.g., exponential functions, normal distributions, etc.).

Some embodiments may include various other labels or graphic elements 170, at various appropriate locations on the ruler. For instance, a first axis may be labeled in one or more appropriate ways (e.g., “X”, “run”, “ΔX”, “x-axis”, etc.). As another example, a second axis may be labeled in one or more appropriate ways (e.g., “Y”, “rise”, “ΔY”, “y-axis”, etc.). Some embodiments may include a center point indicator such as a circle with perpendicular lines located at the center of the ruler. Some embodiments may include equations, instructions, notes, etc. (e.g., “slope=rise/run=ΔY/ΔX”, “(X,Y)”, etc.).

Some embodiments may be adapted to be used by students when plotting ordered pairs (i.e., points defined by a pair of integers representing an x-coordinate and a y-coordinate in a Cartesian coordinate system). The center of the ruler 100 may allow students to align the ruler with a center on a plot area. A student may then place the ruler in a first orientation to determine the appropriate gridline associated with an x-coordinate and may then place the ruler in a second orientation to determine the appropriate gridline associated with the y-coordinate and plot the point associated with the pair of coordinates.

In some embodiments, the ruler may include various through-holes, notches, etc., that may allow a user to easily mark a point along an axis, the secure the ruler to a plot medium, etc.

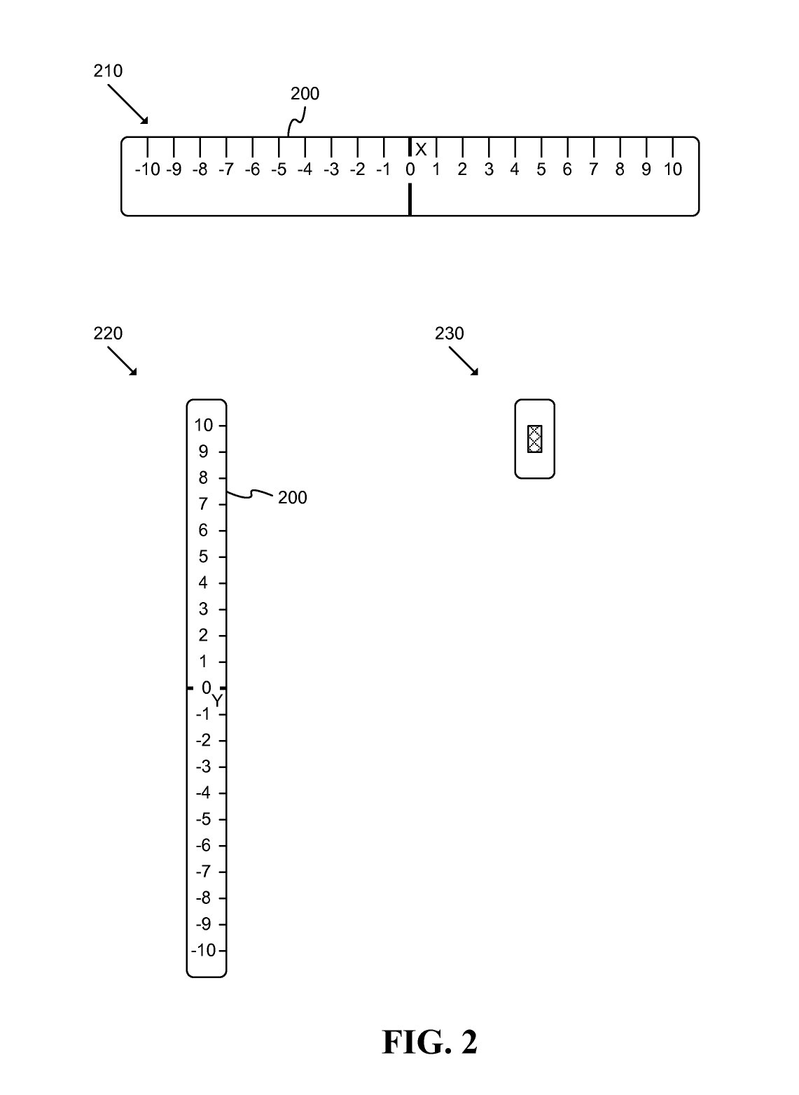

FIG. 2 illustrates front, side, and top views of an alternative graphing ruler 200 according to an exemplary embodiment of the invention. In this example, a first set of markings is placed along a first surface of the ruler 200, while a second set of markings is placed along a second surface perpendicular to the first surface. To change from the first orientation 210 to the second orientation 220, the ruler may be rotated ninety degrees counterclockwise about a first axis and then turned ninety degrees counterclockwise about a second, perpendicular axis to display the second surface. Such a ruler may generally be shaped similarly to a rectangular pencil (e.g., a typical carpenter's pencil), and may include graphite or some other appropriate material such that the ruler may be used to mark various mediums.

Different embodiments may be adapted to use different types of materials (e.g., graphite, ink, etc.) to mark different types of mediums (e.g., paper, wood, etc.). In addition, some embodiments may include markings that are associated with construction or other specific uses (e.g., by facilitating plotting of forty-five degree angles).

Although the examples described above have used two axes, one of ordinary skill in the art will recognize that some embodiments may include more than two axes (e.g., a three-axis ruler). Such a three-axis ruler may include a first element that is substantially similar to the ruler 100 described above in reference to FIG. 1 and a second element that extends along a third axis (e.g., a “Z” axis) and that may be connected to, or otherwise position in relation to, the first element such that a value along the third axis may be determined.

It should be understood, of course, that the foregoing relates to illustrative details of exemplary embodiments of the invention and that modifications may be made without departing from the spirit and scope of the invention as defined by the following claims.

I claim:

1. A multi-axis educational graphing ruler comprising:
a first set of markings placed such that the markings extend vertically if the ruler is placed in a first orientation; and
a second set of markings oriented such that the markings extend horizontally if the ruler is placed in a second orientation that is perpendicular to the first orientation.

2. The multi-axis educational graphing ruler of claim 1 further comprising:
a first set of labels associated with the first set of markings placed such that the labels are upright in the first orientation; and
a second set of labels associated with the second set of markings placed such that the labels are upright in the second orientation.

3. The multi-axis educational graphing ruler of claim 2, wherein the first set of labels comprises a plurality of numbers having positive values and a plurality of numbers having negative values.

4. The multi-axis educational graphing ruler of claim 3, wherein the second set of labels comprises a plurality of numbers having positive values and a plurality of numbers having negative values.

5. The multi-axis educational graphing ruler of claim 1 further comprising a center point indicator aligned with the middle of the first set of markings and the second set of markings.

6. The multi-axis educational graphing ruler of claim 1, wherein the first set of markings is associated with an x-axis in a Cartesian coordinate system.

7. The multi-axis educational graphing ruler of claim 6, wherein the second set of markings is associated with a y-axis in a Cartesian coordinate system.

8. The multi-axis educational graphing ruler of claim 1, wherein the first set of markings is spaced at one-quarter inch intervals.

9. The multi-axis educational graphing ruler of claim 8, wherein the first set of markings is spaced at one-quarter inch intervals.

10. The multi-axis educational graphing ruler of claim 1, wherein the first set of markings is spaced at uniform intervals.

11. The multi-axis educational graphing ruler of claim 10, wherein the second set of markings is spaced at non-uniform intervals.

12. The multi-axis educational graphing ruler of claim 11, wherein the non-uniform intervals are associated with one of a sinusoidal function, a logarithmic function, a trigonometric function, and an exponential function.

13. The multi-axis educational graphing ruler of claim 1, wherein the ruler is constructed of transparent plastic.

14. A ruler comprising:
a first set of markings and labels associated with a first axis; and
a second set of markings and labels associated with a second axis that is perpendicular to the first axis.

15. The ruler of claim 14, wherein the labels include negative integer values and positive integer values.

16. The ruler of claim 14, wherein the first axis is an x axis in a Cartesian coordinate system and the second axis is a y axis in a Cartesian coordinate system.

17. The ruler of claim 14 further comprising a center point indicator.

18. The ruler of claim 14 further comprising a set of usage instructions.

19. A plotting tool comprising:
a first set of markings and labels along a first surface of the tool; and
a second set of markings and labels along a second surface of the tool, wherein the second surface is perpendicular to the first surface.

20. The plotting tool of claim 19, wherein the labels include negative integer values and positive integer values.
